(19) United States
(12) Patent Application Publication
(10) Pub. No.: US 2025/0218012 A1
(43) Pub. Date: Jul. 3, 2025

(54) Three-dimensional (3D) Object Detection Method, Apparatus, Controller, Vehicle, and Medium

(71) Applicant: Robert Bosch GmbH, Stuttgart (DE)

(72) Inventors: Shuyu GE, Suzhou (CN); Yanan WANG, Suzhou (CN); Yazhe TANG, Suzhou (CN); Zhonghao DENG, Suzhou (CN)

(21) Appl. No.: 19/003,086

(22) Filed: Dec. 27, 2024

(30) Foreign Application Priority Data
Dec. 29, 2023 (CN) 2023 1184 8053.4

(51) Int. Cl. G06T 7/50; G06V 10/762; G06V 10/82; G06V 20/56

(52) U.S. Cl. CPC G06T 7/50; G06V 10/762; G06V 10/82; G06V 20/56; G06T 2200/04; G06T 2200/08; G06T 2207/10028; G06T 2207/20084; G06T 2207/30252

(57) ABSTRACT

Methods, apparatuses, controllers, vehicles, and media for three-dimensional (3D) object detection is disclosed. The method includes (i) obtaining a two-dimensional (2D) image of a target 3D scene, (ii) obtaining depth data corresponding to the 2D image, and (iii) detecting 3D objects in the target 3D scene based on the 2D image and depth data using a predetermined neural network model. The method improves the efficiency and accuracy of 3D object detection by using a predetermined neural network model based solely on 2D images and depth data for 3D object detection.

This application claims priority under 35 U.S.C. § 119 to patent application no. CN 2023 1184 8053.4, filed on Dec. 29, 2023 in China, the disclosure of which is incorporated herein by reference in its entirety.

The examples of the present disclosure relate to the field of data processing, specifically to methods, apparatuses, controllers, vehicles, and media for three-dimensional (3D) object detection.

### BACKGROUND

With the development of smart devices, the demand for object detection in scenes is increasing, and in an increasing number of applications, it is necessary to detect objects in three-dimensional (3D) scenes (such as roads, office areas, or playgrounds). For example, during the autonomous or assisted driving of a vehicle, it is necessary to detect objects (such as other vehicles or pedestrians) in the 3D driving scene to determine the driving operations to be performed. For such applications, the accuracy of object detection may directly affect user safety, making the efficiency and accuracy of object detection extremely important.

### SUMMARY

Embodiments of the present disclosure provide a method, apparatus, controller, vehicle, and medium for three-dimensional (3D) object detection.

According to a first aspect of the present disclosure, a method for 3D object detection is provided. The method includes obtaining a two-dimensional (2D) image of a target 3D scene. The method further comprises obtaining depth data corresponding to the 2D image. The method further comprises detecting 3D objects in the target 3D scene based on the 2D image and depth data using a predetermined neural network model.

According to a second aspect of the present disclosure, an apparatus for 3D object detection is provided. The apparatus includes an obtaining unit configured to obtain a two-dimensional 2D image of a target 3D scene. The apparatus further comprises a generation unit configured to obtain depth data corresponding to the 2D image. The apparatus also includes a detection unit configured to detect 3D objects in a target 3D scene based on the 2D image and depth data using a predetermined neural network model.

According to a third aspect of the present disclosure, a controller is provided. The controller comprises at least one processor; and a memory coupled to the at least one processor and having instructions stored thereon that, when executed by the at least one processor, cause the controller to implement the method according to the first aspect of the present disclosure.

According to a fourth aspect of the present disclosure, a vehicle is provided. The vehicle includes a controller according to a third aspect of the present disclosure and a predetermined neural network model according to a first aspect of the present disclosure.

In a fifth aspect of the present disclosure, a computer-readable storage medium is provided. The computer-readable storage medium has computer-executable instructions stored thereon, wherein the computer-executable instructions are executed by a processor to implement the method according to the first aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same reference number typically represents the same parts.

FIG. 1 illustrates a schematic diagram of an exemplary environment in which the device and/or method according to examples of the present disclosure may be implemented.

FIG. 2 illustrates a flowchart of a method for three-dimensional (3D) object detection according to examples of the present disclosure.

FIG. 3 illustrates a schematic block diagram of an example of a predetermined neural network model, consistent with examples of the present disclosure.

FIG. 4A illustrates a schematic diagram of an example of a process for obtaining a first neural network model, consistent with examples of the present disclosure.

FIG. 4B illustrates a schematic diagram of an example of a process for obtaining a model anchor of a first neural network model, consistent with examples of the present disclosure.

FIG. 5 illustrates a schematic diagram of an example of a process for detecting 3D objects in a 3D scene, consistent with examples of the present disclosure.

FIG. 6 illustrates a schematic diagram of an example of a process for obtaining first model detection results from a first neural network model, consistent with examples of the present disclosure.

FIG. 7 illustrates a schematic diagram of an example of a process for determining a 3D object from a second neural network model, consistent with examples of the present disclosure.

FIG. 8 illustrates a schematic block diagram of an apparatus for 3D object detection according to an example of the present disclosure.

FIG. 9 illustrates a schematic block diagram of one example of an exemplary device according to an example that is suitable to embody the content of the present disclosure.

In the various accompanying drawings, the same or corresponding numbers represent the same or corresponding portions.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first”, “second”, etc. may refer to and represent different or the same object. Other explicit and implicit definitions may be included below.

With the development of smart devices, the need for object detection of objects in a scene is increasing. For example, for autonomous or assisted driving of a vehicle, a perceived module of the vehicle perceives the environment surrounding the vehicle (e.g., 3D object detection of objects in a three-dimensional (3D) road scene) as the “eyes” of the vehicle for determining the driving operation to be performed is important for the safety of the vehicle and the user. For example, the sensing module may detect objects on the road (e.g., other vehicles, traffic lights, pedestrians, sidewalks, lane lines, and building or obstacle) based on radar point clouds detected by the Lidar or images captured by cameras.

The Lidar, due to its physical properties, assists in relatively accurate object detection. However, the Lidar is susceptible to weather conditions, such as rain and snow, which renders it unfit for a variety of driving environments. In addition, the cost of the Lidar is high, resulting in its inability to be assembled in some vehicles that require cost savings. Thus, there is growing interest in how 3D object detection is performed based on two-dimensional (2D) images captured from a monocular camera for a target 3D scene (e.g., a road scene).

Typically, the 3D object detection may be performed based on the 2D image using a neural network model. The neural network model for such 3D object detection may be classified as a non-anchor-free type and an arch-based type. For example, SMOKE (Single-Stage Monocular 3D Object Detection via Keypoint Estimation) is a neural network model of such a type of non-anchoring point. For example, the M3D-RPN (single 3D-region candidate frame detection network) is a neural network model of the anchor type. Anchors of this type of neural network model with anchors may generally be classified as 2D anchors and 3D anchors. For this neural network model with 2D anchors, the input includes only the 2D information, e.g., the 2D image; and for this neural network model with 3D anchors, the input needs to include 3D information about the object, e.g., position, size, and orientation information under the camera coordinate system, etc.

However, the above-described anchor-free neural network model, while easy to develop and train without too many preset parameters, due to its limitations itself, results in lower detection precision and difficulty in fully detecting objects in the 3D scene (i.e., lower recall rate). Thus, for autonomous or assisted driving processes of a vehicle, for example, there may be a security hazard, for example, collision of the vehicle with an obstacle may occur due to undetected obstacles on the road, etc. Further, such a 3D object detection method is a 3D information reconstruction of an object from a 2D image, which by itself results in a larger error.

Moreover, the neural network model with 2D anchors described above is also based solely on the 2D image to reconstruct the 3D information of the object, and in particular cannot accurately predict the depth of the adjacent object. Moreover, the above-described neural network model with 3D anchors requires a large amount of 3D information (e.g., position, size, and orientation information under the camera coordinate system), resulting in a large amount of computing, which requires a large amount of computing resources to be used for a vehicle with limited computing resources and inefficient 3D object detection.

To address at least the aforementioned and other potential issues, examples of the present disclosure provide a method for 3D object detection. The method comprises obtaining a 2D image of a target 3D scene. The method further comprises obtaining depth data corresponding to the 2D image. The method further comprises detecting 3D objects in the target 3D scene based on the 2D image and depth data using a predetermined neural network model. The method according to an example of the present disclosure improves the efficiency and accuracy of 3D object detection by using a predetermined neural network model according to examples of the present disclosure based solely on 2D images and depth data for 3D object detection.

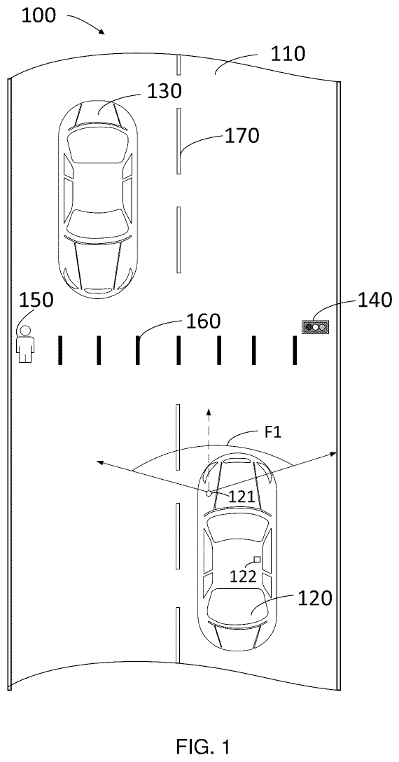

Below, examples of the present disclosure will be described in detail with reference to the accompanying drawings. FIG. 1 illustrates a schematic diagram of an exemplary environment 100 in which the device and/or method according to examples of the present disclosure may be implemented. As shown in FIG. 1, the vehicle 120 and vehicle 130 traveling on the road 110 are shown in the environment 100. In some examples, the vehicle 120 and the vehicle 130 may be vehicles capable of autonomous or assisted driving, illustrated below with the vehicle 120 as an example. In some examples, the vehicle 120 may have a camera 121 (e.g., a monocular camera), such as a camera 121 may have a larger photographic viewing angle F1 (e.g., 120°) to more fully capture a 2D image of a target 3D scene (i.e., a scene of the road 110).

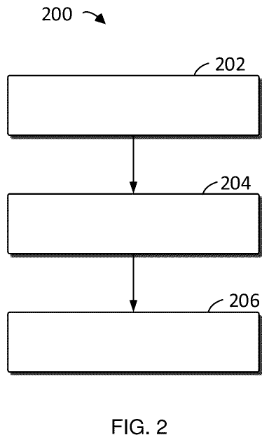

In some examples, the vehicle 120 may also have a controller 122 that may be used to communicate with the camera 121 to receive 2D images taken by the camera 121. Further, in some examples, the vehicle 120 may also have a unit (e.g., a radar) for obtaining depth data corresponding to the 2D images taken by the camera 121. Controller 122 may also communicate with the unit to receive depth data from the unit. Further, the vehicle 120 may also have a predetermined neural network model included in or coupled to the controller 122 (which will be described further in the following examples) to enable the controller 122 to use the predetermined neural network model for 3D object detection based on the 2D image and depth data. For example, the controller 122 is capable of detecting other vehicles 130, traffic signal lights 140, pedestrians 150, sidewalks 160, and lane lines 170, among others, in the scene of the road 110 shown in FIG. 1. It should be understood that these detection objects are merely examples and that any other objects, such as other obstacles or buildings, may also be detected depending on the target 3D scene. Examples of 3D object detection are described below in conjunction with the examples shown in FIGS. 2-7.

FIG. 2 illustrates a flowchart of a method 200 for 3D object detection according to an example of the present disclosure. The method 200 may be performed by any controller (e.g., the controller 122 shown in FIG. 1) or an electronic device or server, in conjunction with a predetermined neural network model consistent with examples of the present disclosure. As shown in FIG. 2, at block 202, a 2D image of a target 3D scene is obtained. For example, the target 3D scene may be the scene of the road 110 shown in FIG. 1, and the obtained 2D image may be a 2D image of the scene of the road 110 captured by the camera 121 on the vehicle 120 of FIG. 1. It should be understood that the target 3D scene may also be any other scene, such as an office area, or playground, etc. At block 204, depth data corresponding to the 2D image is obtained. In some examples, the depth data corresponding to the 2D object may be obtained via a radar on the vehicle. For example, the radar may be of any type.

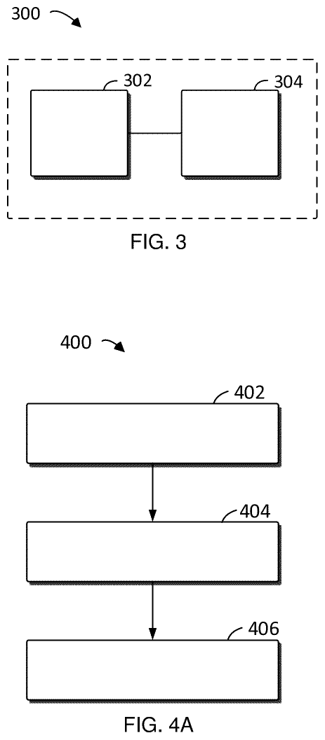

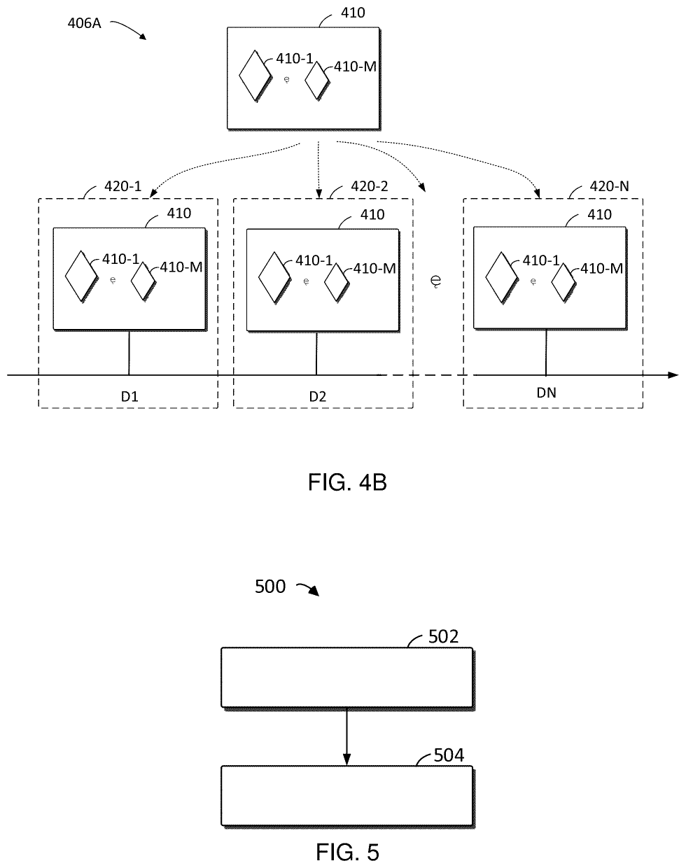

At block 206, 3D objects in a target 3D scene are detected based on the 2D image and depth data using a predetermined neural network model. For example, other vehicles 130, traffic signal lights 140, pedestrians 150, sidewalks 160, and lane lines 170, etc., shown in FIG. 1, can be detected, or other obstacles or buildings can be detected, etc. The method according to an example of the present disclosure improves the efficiency and accuracy of 3D object detection by using a predetermined neural network model according to examples of the present disclosure based solely on 2D images and depth data for 3D object detection. An example of a predetermined neural network model consistent with examples of the present disclosure will be described below in conjunction with FIGS. 3 and 4.

FIG. 3 illustrates a schematic block diagram of an example of a predetermined neural network model 300, consistent with examples of the present disclosure. As shown in FIG. 3, the predetermined neural network model 300, consistent with examples of the present disclosure, may include a first neural network model 302 and a second neural network model 304. In some examples, the first neural network model 302 may be obtained based on the 2D object detection neural network model. In some examples, the second neural network model 304 may be a 3D object detection task head neural network model.

In some examples, the 2D object detection neural network model for obtaining the first neural network model 302 may be a neural network model with 2D anchor points (e.g., YOLOv5 or any other neural network model) for single-stage 2D object detection. FIG. 4A illustrates a schematic diagram of an example of a process 400 for obtaining the first neural network model 302, consistent with examples of the present disclosure. As shown in FIG. 4A, at block 402, predetermined depth data may be obtained. For example, the predetermined depth data may be training depth data in training data used to train the first neural network model 302 to be obtained, or may be other depth data different from the training depth data. At block 404, the predetermined depth data may be clustered to cluster the predetermined depth data as a plurality of clusters. For example, a K-mean algorithm may be used to cluster predetermined depth data.

At block 406, the first neural network model 302 may be obtained by setting a 2D anchor into each of a plurality of clusters to obtain a model anchor for each cluster. In some examples, the above settings for the 2D anchor may cause: For each cluster, the 2D anchor is associated with a center value of the predetermined depth data in the cluster to obtain a model anchor for that cluster. In some examples, the number of 2D anchors that the 2D object detection neural network model has for obtaining the first neural network model 302 may be a first number. In some examples, the number of clusters for which predetermined depth data is clustered may be a second number. In some examples, the number of all of the model anchors obtained for the first neural network model 302 may be a product of the first number and the second number. This may be further understood with reference to the example of the process for obtaining the model anchor described in FIG. 4B below.

FIG. 4B illustrates a schematic diagram of an example of a process 406A for obtaining a model anchor of the first neural network model 302, consistent with examples of the present disclosure. The process 406A as shown in FIG. 4B corresponds to block 406 of FIG. 4A. The 2D anchor 410 shown in FIG. 4B may be a 2D anchor for obtaining a 2D object detection neural network model of the first neural network model 302. The 2D anchor 410 may include M 2D anchors 410-1 to 410-M, M can be integers greater than or equal to 1. The number of clusters for which the predetermined depth data is clustered at block 406 of FIG. 4A may be N, which is an integer greater than or equal to 1. As shown in FIG. 4B, the center values of the predetermined depth data in the N clusters of clustered classes may be D1, D2, . . . , DN, respectively.

As shown in FIG. 4B, the 2D anchor 410 is each set into each cluster and is associated with a center value D1, D2, . . . , DN for each cluster to obtain corresponding model anchors 420-1, 420-2, . . . , 420-N. By generating these model anchor points 420-1, 420-2, . . . , 420-N as described above, a first neural network model 302 may be obtained, consistent with examples of the present disclosure. As such, the first neural network model 302 may detect 2D objects in the 2D image and may also predict a predicted depth of the detected 2D objects. In some examples, the first neural network model 302 can be trained to perform the desired 2D object detection as well as depth prediction.

In some examples, the first neural network model 302 may be trained using training depth data (e.g., may be predetermined depth data as described above), corresponding training 2D images, and a “ground true” value. In some examples, in the course of training, the first neural network model 302 may receive the training 2D image and feature extract the training 2D image to obtain a feature map, which is then divided into a plurality of sub-graphs (e.g., grids). Thereafter, each of the model anchor points 420-1, 420-2, . . . , 420-N of the first neural network model 302 may output a 2D detection object (e.g., a 2D boundary box that outputs a 2D detection object) for each of the sub-graphs, and corresponding training depth data. Thereafter, the output of the model anchor with the output closest to the ground true value is selected as the final output of the first neural network model for the sub-graph based on the intersection of the 2D boundary box output for each model anchor with the corresponding boundary box indicated with the ground true value and the difference between the predicted depth of each model anchor output and the corresponding depth marked with the ground true value. In some examples, in particular, in training aspects of depth prediction, the depth prediction may be made using the linear prediction manner shown in equation (1) below due to having the depth data entered.

$$Z = pred [ 0 ] * depth\_center \_x \_std + depth\_center \_x \_mean \qquad ( 1 )$$

In equation (1), Z represents the predicted value of the depth and pred[0] represents the normalized depth value output by the first neural network model. depth_center_x_std represents the standard deviation of the training depth data for the xth cluster, x is an integer greater than or equal to 1 and less than or equal to N. depth_center_x_mean represents the average of the training depth data for the xth cluster. In some examples, e.g., training for a depth prediction, the training may be ended when the change in the ground true value of the depth predicted by the first neural network is less than a predetermined change threshold, or when the difference between the ground true value of the predicted depth relative to the depth is less than a predetermined difference threshold. It should be understood that training may also be ended on other terms depending on the actual need, such as the rounds of training reaching the round threshold, etc. It should be understood that training end conditions for training on 2D object detection may be similar or that the depth prediction training and 2D object detection training may have associated training end conditions.

Further, in some examples, the second neural network model 304 shown in FIG. 3 may also be pre-trained. The training data of the second neural network model 304 may include, for example, training data corresponding to the output of the first neural network model 302, anchor point parameters (e.g., center values) of the model anchor point of the first neural network model 302, and camera parameters (these are inputs to the second neural network model 304), and the training data may also include corresponding 3D objects ground true values. The training process of the second neural network model 304 is similar to the training process of the first neural network model 302 and will not be repeated. The process of 3D object detection by the trained first neural network model 302 and the trained second neural network model 304 according to examples of the present disclosure will be described below with reference to the examples of FIGS. 5-7, in conjunction with the method 200 of the examples of the present disclosure shown in FIG. 2.

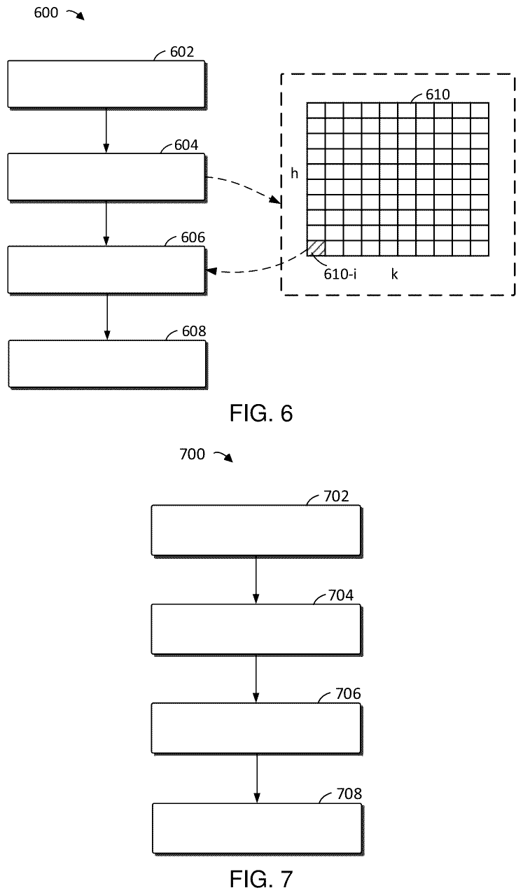

FIG. 5 illustrates a schematic diagram of an example of a process 500 for detecting 3D objects in a 3D scene, consistent with examples of the present disclosure. The process 500 shown in FIG. 5 corresponds to block 206 shown in FIG. 2. As shown in FIG. 5, at block 502, a first model detection result may be obtained using the first neural network model 302 based on the 2D image obtained at block 202 of FIG. 2 and the depth data obtained at block 204 of FIG. 2. In some examples, the first model detection result may include a 2D detection object (e.g., a boundary box of the 2D detection object) for the 2D image and a predicted depth for the 2D detection object. At block 504, the 3D object corresponding to the 2D detection object may be determined using the second neural network model 304 based on the first model detection result and corresponding parameters. In some examples, the corresponding parameters may include anchor point parameters of the model anchor point in the first neural network model. In some examples, the corresponding parameters may include camera parameters for a camera (e.g., the camera 121 shown in FIG. 1) that captures the 2D image. Block 502 and block 504 are described further below in conjunction with the examples shown in FIGS. 6 and 7.

FIG. 6 illustrates a schematic diagram of an example of a process 600 for obtaining a first model detection result by the first neural network model 302, consistent with examples of the present disclosure. The process 600 shown in FIG. 6 corresponds to block 502 shown in FIG. 5. As shown in FIG. 6, at block 602, a feature diagram 610 of the 2D image may be obtained using the first neural network model 302 for feature extraction of the 2D image. At block 604, the feature diagram 610 may be divided into a plurality of sub-graphs. For example, as shown in FIG. 6, feature diagram 610 is divided into multiple sub-graphs of the k-line h column, both k and h being integers greater than or equal to 1. At block 606, the results of the corresponding anchor detection may be obtained using all of the model anchor points 420-1, 420-2, . . . , 420-N, respectively, for each of the plurality of sub-graphs (for ease of description, illustrated below with the sub-graph 610-i shown in FIG. 6, which is an integer greater than or equal to 1 and less than or equal to k*h).

In some examples, the corresponding anchor detection result may include a corresponding 2D detection objects for the sub-graphs 610-i. In some examples, the corresponding anchor detection result may further include a corresponding predicted depth for the corresponding 2D detection objects. In some examples, the corresponding predicted depth is obtained based on each of the model anchors 420-1, 420-2, . . . , 420-N in the first neural network model 302: Mean and standard deviation of corresponding depth data in the depth data corresponding to sub-graphs 610-i. For example, the predicted depth may be obtained in a manner similar to equation (1) above, except that the depth_center_x_std in equation (1) may here represent a standard deviation of the depth data described above for the xth cluster, and the depth_center_x_mean may here represent a mean of the depth data described above for the xth cluster.

At block 608, a target anchor detection result may be selected from all anchor detection results based on a non-maximum suppression (NMS) as the sub-graph detection result for that sub-graph 610-i. The output of the first neural network model 302, i.e., the first model detection result described above, can be obtained thereby. In some examples, the above-described first model detection results may include the results of the sub-graph detection for each of the sub-graphs. The first model detection result may be used by the second neural network model 304 to determine the 3D object.

FIG. 7 illustrates a schematic diagram of an example of a process 700 for determining a 3D object by the second neural network model 304, consistent with examples of the present disclosure. The process 700 shown in FIG. 7 corresponds to block 504 shown in FIG. 5. In some examples, the second neural network model 304 may be a 3D object detection task head neural network model having eight channels that perform the process 700 shown in FIG. 7. As shown in FIG. 7, at block 702, for each of the plurality of sub-graphs (k*h sub-graphs) 610-i, the second neural network model 304 may provide the corresponding predicted depth included in the sub-graph detection results of the sub-graphs 610-i as the predicted depth corresponding to the corresponding 3D object of the 2D detection objects included in the sub-graph detection results. In some examples, a first channel of the second neural network model 304 is used to obtain a predicted depth of a corresponding 3D object.

At block 704, the direction of the corresponding 3D object in the top view may be obtained based on the predicted depth and the center point of the model anchor point (described below with the model anchor point 410-2 shown in FIG. 4) used to obtain the results of the sub-graph detection results (for ease of description, as will be appreciated). In some examples, the second channel and the third channel of the second neural network model 304 may be used to obtain a direction in the top view of a corresponding 3D object. In some examples, the second neural network model 304 may obtain the orientation of the corresponding 3D object in the top view by equation (2), equation (3), and equation (4) below.

$$θ = {α}_{z} + arctan ( X / {Z}^{′} ) \qquad ( 2 )$$

$$sin ( {α}_{z} ) = pred [ 1 ] \qquad ( 3 )$$

$$cos ( {α}_{z} ) = pred [ 2 ] \qquad ( 4 )$$

In equations (2) to (4) above, X represents the above-defined cross-sectional in the top view of the center point of the model anchor point 420-2 at the camera coordinate system, and Z′ denotes the longitudinal coordinate in the top view at the camera coordinate system of the center point of the model anchor point 420-2. Pred[1] represents the output of the second channel of the second neural network model 304, pred[2] represents the output of the third channel of the second neural network model 304, and e represents the supervision signal of the pred[1] and pred[2]. α₂ represents the direction in the top view of the predicted corresponding 3D object.

At block 706, the predicted length, predicted width, and predicted height of the corresponding 3D object may be obtained based on the preset average length, preset average width, and preset average height corresponding to the type of 2D detected object (e.g., vehicle type) described above. In some examples, the fourth channel to the sixth channel of the second neural network model 304 may be used to obtain a predicted length, a predicted width, and a predicted height of a corresponding 3D object. In some examples, the second neural network model 304 may obtain the predicted length, predicted width, and predicted height of the corresponding 3D object by equation (5), equation (6), and equation (7) below.

$$dim\_h = \overline{h} * exp ( pred [ 3 ] ) \qquad ( 5 )$$

$$dim\_w = \overline{w} * exp ( pred [ 4 ] ) \qquad ( 6 )$$

$$dim\_l = \overline{l} * exp ( pred [ 5 ] ) \qquad ( 7 )$$

In the above equations (5) to (7), and represent a preset average length, a preset average width l̅, h̅ and a preset average height corresponding to the types of 2D detection objects described above, w̅ respectively. For example, l̅, h̅ and w̅ may be set according to actual needs. The pred[3] represents the output of the fourth channel of the second neural network model 304, the pred[4] represents the output of the fifth channel of the second neural network model 304, and the pred[5] represents the output of the sixth channel of the second neural network model 304. dim_l, dim_w, and dim_h represent the predicted length, predicted width, and predicted height of the corresponding 3D object, respectively.

At block 708, the location of the corresponding 3D object in the 3D space may be obtained based on the above-described predicted depth, predicted length, predicted width, predicted height, and camera parameters (e.g., camera parameters of the camera 121). In some examples, the seventh and eighth channels of the second neural network model 304 may be used to obtain a location of a corresponding 3D object in the 3D space. In some examples, the second neural network model 304 may obtain a location of a corresponding 3D object in the 3D space by following equations (8), (9), and (10).

$$proj\_center \_u = stride * ( grid\_u + pred [ 6 ] ) \qquad ( 8 )$$

$$proj\_center \_v = stride * ( grid\_v + pred [ 7 ] ) \qquad ( 9 )$$

$$Z [ \begin{matrix}proj\_center \_u \\ proj\_center \_v \\ 1\end{matrix} ] = {K}_{3 \times 3} [ \begin{matrix}X \\ Y \\ {Z}^{′}\end{matrix} ] \qquad ( 10 )$$

In equation (8) to equation (10) above, grid_u and grid_v represent the central points of the sub-graph 610-i of feature FIG. 610, proj_center_u and proj_center_v represent the central points of the predicted 2D detection object for sub-graph 610-i. The pred[6] represents the output of the seventh channel of the second neural network model 304 and the pred[7] represents the output of the eighth channel of the second neural network model 304. K_{3×3} represents a camera parameter matrix for the camera. (X, Y, Z′) indicates the coordinates of the corresponding 3D object under the camera coordinates above, i.e., the positions of the corresponding 3D object in the 3D space.

By way of the foregoing, the predetermined neural network model 300 in accordance with the present disclosure can only conduct single-stage 3D object detection based on 2D images and corresponding depth data without requiring substantial 3D data to perform a large amount of calculation, thereby increasing the efficiency of 3D object detection. Further, the above-described predetermined neural network model in accordance with examples of the present disclosure uses a linear approach to predict depths without the need for complex calculations, thereby further improving the efficiency of 3D object detection. Further, model anchors suitable for use in the above-described predetermined neural network model of the present disclosure are created, such that the above-described predetermined neural network model has a higher recall rate of 3D object detection of the target 3D space, i.e., the probability that an actual 3D object is not detected can be greatly reduced. Moreover, since the predetermined neural network model described above utilizes real depth data rather than 2D information to infer 3D information, the accuracy of 3D object detection may be improved.

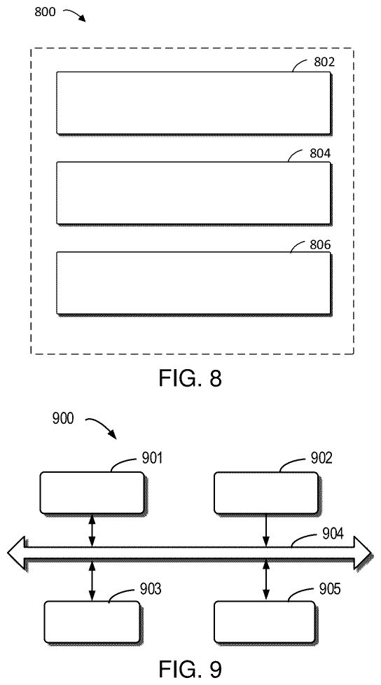

FIG. 8 illustrates a schematic block diagram of an apparatus 800 for 3D object detection according to an example of the present disclosure. As shown in FIG. 8, the apparatus 800 includes a obtaining unit 802 configured to obtain a two-dimensional 2D image of a 3D scene of interest. The apparatus 800 also includes a generation unit 804 configured to obtain depth data corresponding to the 2D image. The apparatus 800 also includes a detection unit 806 configured to detect 3D objects in a target 3D scene using a predetermined neural network model based on the 2D image and depth data.

In some examples, the predetermined neural network model may include a first neural network model and a second neural network model. In some examples, the first neural network model may be obtained based on the 2D object detection neural network model. In some examples, the 2D object detection neural network model may be a neural network model having a 2D anchor for single-stage 2D object detection. In some examples, the second neural network model may be a 3D object detection task head neural network model.

In some examples, the apparatus 800 may further comprise a model obtaining unit, which may be configured to obtain a first neural network model based on the 2D object detection neural network model. In some examples, the model obtaining unit may be configured to obtain predetermined depth data. In some examples, the model obtaining unit may be configured to cluster predetermined depth data to cluster predetermined depth data as a plurality of clusters. In some examples, the model obtaining unit may be configured to obtain a first neural network model by setting a 2D anchor into each cluster of the plurality of clusters to obtain a model anchor for each cluster. In some examples, the setting may be such that for each cluster, the 2D anchor is associated with a center value of the predetermined depth data in the cluster to obtain a model anchor for the cluster. In some examples, the number of 2D anchors may be a first number. In some examples, the number of clusters may be a second number. In some examples, the number of all of the model anchors obtained for the first neural network model may be a product of the first number and the second number.

In some examples, the detection unit 806 may be configured to obtain a first model detection result based on the 2D image and depth data using the first neural network model. In some examples, the first model detection result may comprise a 2D detection object for the 2D image. In some examples, the first model detection result may comprise a predicted depth for the 2D detection object.

In some examples, the detection unit 806 may be configured to extract a feature of the 2D image to obtain a feature of the 2D image using a first neural network model. In some examples, the detection unit 806 may be configured to divide the feature map into a plurality of sub-graphs. In some examples, the detection unit 806 may be configured to obtain a corresponding anchor detection result for each of the plurality of sub-graphs using all of the model anchors, respectively. In some examples, the corresponding anchor detection result may comprise a corresponding 2D detection object for the sub-graph. In some examples, the corresponding anchor detection result may comprise a corresponding predicted depth for the corresponding 2D detection object. In some examples, the corresponding predicted depth may be obtained for each of the model anchors in all of the model anchors in the first neural network model based on: Mean and standard deviation of corresponding depth data in the depth data corresponding to sub-graphs. In some examples, the detection unit 806 may be configured to select a target anchor detection result from all anchor detection results based on a non-maximum suppression as the sub-graph detection result for the sub-graph. In some examples, the first model detection results may include the results of the sub-graph detection for each of the sub-graphs.

In some examples, the detection unit 806 may be configured to determine a 3D object corresponding to the 2D detection object based on the first model detection result and corresponding parameters using the second neural network model. In some examples, the corresponding parameters may include anchor point parameters of the model anchor point in the first neural network model. In some examples, the corresponding parameters may include camera parameters of a camera for capturing the 2D image.

In some examples, the detection unit 806 may be configured to use the corresponding predicted depth included in the results of the sub-graphs as the predicted depth of the corresponding 3D object corresponding to the corresponding 2D detection object included in the results of the sub-graphs for each of the plurality of sub-graphs. In some examples, the detection unit 806 may be configured to obtain the orientation of the corresponding 3D object in the top view based on the predicted depth and the center point of the model anchor point for obtaining the sub-graph detection result. In some examples, the detection unit 806 may be configured to obtain a predicted length, a predicted width, and a predicted height of a corresponding 3D object based on a preset average length, a preset average width, and a preset average height corresponding to the type of the 2D detected object. In some examples, the detection unit 806 may be configured to obtain a location of a corresponding 3D object in the 3D space based on the predicted depth, predicted length, predicted width, predicted height, and camera parameters.

The apparatus 800, according to examples of the present disclosure, improves the efficiency and accuracy of 3D object detection by using a predetermined neural network model according to examples of the present disclosure based solely on the 2D image and depth data for 3D object detection.

FIG. 9 illustrates a schematic block diagram of an exemplary device 900 suitable for implementing the examples of the present disclosure. The above-mentioned controller can be implemented using the device 900. As shown, the device 900 includes a processor 901, which can perform various appropriate actions and processes according to computer program instructions stored in a read-only memory (ROM) 902 and loaded into a random-access memory (RAM) 903. Various programs and data required for the operation of the device 900 may also be stored in the RAM 903. The processor 901, the ROM 902, and the RAM 903 are interconnected through a bus 904. An input/output (I/O) interface 905 is also connected to the bus 904.

The various processes and procedures described above, such as method 200 and process 400, 406A, 500, 600, 700, can be executed by processor 901. For example, in some embodiments, method 200 and process 400, 406A, 500, 600, 700 can be implemented as a computer software program that is tangibly embodied in a machine-readable medium. In some examples, part or all of the computer programs may be loaded and/or installed onto the device 900 through the ROM 902. When the computer program is loaded onto the RAM 903 and executed by the processor 901, one or more actions of the methods 200 and process 400, 406A, 500, 600, 700 described above may be performed.

The present disclosure may be a method, apparatus, system and/or computer program product. The computer program product may comprise a computer-readable storage medium uploaded with computer-readable program instructions for performing various aspects of the present disclosure.

The computer-readable storage medium may be a tangible device that maintains and stores instructions used to instruct execution devices. The computer-readable storage medium, for example, may be—but is not limited to—an electrical storage device, magnetic storage device, optical storage device, electromagnetic storage device, semiconductor memory device, or any suitable combination of the above. More specific examples of the computer-readable storage medium (a non-exhaustive list) comprise: a portable computer disk, a hard disk, a random access memory (RAM), a read-only memory (ROM), an erasable programmable read-only memory (EPROM or flash), a static random access memory (SRAM), a portable compact disc read-only memory (CD-ROM), a digital versatile disc (DVD), a memory stick, a floppy disk, or a mechanical coder, such as a punch card with instructions or structures with protrusions in grooves or indentations, as well as any suitable combinations of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The computer-readable program instructions described herein may be downloaded to various computing/processing devices from computer-readable storage medium, or downloaded from networks, such as the Internet, a local area network, a wide-area network and/or a wireless network to external computers or external storage devices. The networks may comprise copper transmission cables, optical fiber transmissions, wireless transmissions, routers, firewalls, switches, gateway computers, and/or edge servers. The network adapter card or network interface in each computing/processing device receives the computer-readable program instructions from the network and forwards the computer-readable program instructions for storage in computer-readable storage medium of each computing/processing device.

The computer program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. Computer-readable program instructions may be fully executed on the user's computer, partially executed on the user's computer, executed as an independent software package, partially executed on the user's computer and partially executed on a remote computer, or fully executed on a remote computer or server. Where a remote computer is involved, the remote computer may be connected to the user's computer through any type of network, including local area network (LAN) or wide area network (WAN), or it may be connected to an external computer (such as by using an Internet service provider for Internet connection). In some examples, the state information of computer-readable program instructions is used to personalize custom electronic circuits, such as a programmable logic circuit, field-programmable gate array (FPGA) or programmable logic array (PLA), wherein the electronic circuit is able to execute computer-readable program instructions, thereby achieving the various aspects of the present disclosure.

What is claimed is:

1. A method for three-dimensional (3D) object detection, comprising:
obtaining a two-dimensional (2D) image of a target 3D scene;
obtaining depth data corresponding to the 2D image; and
detecting a 3D object in the target 3D scene based on the 2D image and the depth data using a predetermined neural network model.

2. The method of claim 1, wherein:
the predetermined neural network model comprises a first neural network model and a second neural network model,
the first neural network model is obtained based on a 2D object-detection neural network model, the second neural network model being a 3D object-detection task head neural network model, and
the 2D object detection neural network model is a neural network model having a 2D anchor for single-stage 2D object detection.

3. The method of claim 2, further comprising:
obtaining the first neural network model based on the 2D object detection neural network model;
obtaining predetermined depth data;
clustering the predetermined depth data to cluster the predetermined depth data as a plurality of clusters; and
obtaining the first neural network model by setting the 2D anchor into each cluster of the plurality of clusters to obtain a model anchor for each cluster,
wherein the setting is such that for each cluster, the 2D anchor is associated with a center value of the predetermined depth data in the cluster to obtain a model anchor for the cluster.

4. The method of claim 3, wherein detecting 3D objects in the target 3D scene based on the 2D image and the depth data using a predetermined neural network model, comprises:
using the first neural network model to obtain a first model detection result based on the 2D image and the depth data; and
determining, using the second neural network model, a 3D object corresponding to the 2D detection object based on the first model detection result and corresponding parameters,
wherein the first model detection result comprises a 2D detection object for the 2D image and a predicted depth for the 2D detection object, and
wherein the corresponding parameters comprise: anchor point parameters of a model anchor point in the first neural network model, and camera parameters of a camera for capturing the 2D image.

5. The method of claim 4, wherein using the first neural network model to obtain a first model detection result based on the 2D image and the depth data, comprises:
using the first neural network model to extract features from the 2D image to obtain a feature map of the 2D image;
divide the feature diagram into a plurality of sub-graphs;
obtaining a corresponding anchor detection result using all of the model anchors, respectively, for each of the plurality of sub-graphs; and
selecting a target anchor detection result from all anchor detection results based on a non-maximum suppression (NMS) as the sub-graph detection result for the sub-graph,
wherein the corresponding anchor detection result comprises: predict a depth for a corresponding 2D detection object of the sub-graph and a corresponding prediction depth for the corresponding 2D detection object, and
wherein the first model detection result comprises a sub-graph detection result for each sub-graph.

6. The method of claim 5, wherein using the second neural network model to determine a 3D object corresponding to the 2D detection object based on the first model detection result and corresponding parameters comprises:
for each of the plurality of sub-graphs, the corresponding predicted depth included in the sub-graph detection result is used as the predicted depth of the corresponding 3D object corresponding to the corresponding 2D detection object included in the sub-graph detection result;
obtaining a direction of the corresponding 3D object in a top view based on the predicted depth and a center point of a model anchor point for obtaining the sub-graph detection result;
obtaining a predicted length, a predicted width, and a predicted height of the corresponding 3D object based on a preset average length, a preset average width, and a preset average height corresponding to a type of the 2D detection object; and
obtaining a location of the corresponding 3D object in the 3D space based on the predicted depth, the predicted length, the predicted width, the predicted height, and the camera parameters.

7. The method of claim 5, wherein a corresponding predicted depth is obtained for each of the model anchors in all of the model anchors in the first neural network model based on: the mean and standard deviation of the corresponding depth data corresponding to the sub-graph in the depth data.

8. The method of claim 3, wherein the number of 2D anchors is a first number, the number of clusters is a second number, and the number of all model anchors in the first neural network model is a product of the first number and the second number.

9. An apparatus for three-dimensional (3D) object detection, comprising:
an obtaining unit configured to obtain a two-dimensional (2D) image of a 3D scene of a target;
a generation unit configured to obtain depth data corresponding to the 2D image; and
a detection unit configured to detect 3D objects in the target 3D scene based on the 2D image and the depth data using a predetermined neural network model.

10. A controller, comprising:
at least one processor; and
a memory, coupled to the at least one processor, and having instructions stored thereon that, when executed by the at least one processor, cause the controller to perform the method according to claim 1.

11. A vehicle comprising the controller of claim 10 and the predetermined neural network model.

12. A computer-readable storage medium having stored thereon computer-executable instructions, wherein the computer-executable instructions are executed by the processor to perform the method according to claim 1.
